(19) United States
(12) Patent Application Publication
(10) Pub. No.: US 2013/0258801 A1
(43) Pub. Date: Oct. 3, 2013

(54) MIXING APPARATUS AND METHOD FOR MIXING FLUIDS

(71) Applicant: Sabina Beijne, (US)

(72) Inventors: Cristhian Paul Almeida Rivera, Vlaardingen (NL); Petrus Martinus M Bongers, Vlaardingen (NL); Michael John Egan, Liverpool (GB); Graeme Neil Irving, Bebington (GB); Adam Jan Kowalski, Bebington (GB)

(73) Assignee: HINDUSTAN UNILEVER LIMITED, Mumbai (IN)

(21) Appl. No.: 13/884,635

(22) PCT Filed: Oct. 28, 2011
(86) PCT No.: PCT/EP2011/068939

§ 371 Date: Jun. 24, 2013

(30) Foreign Application Priority Data
Nov. 15, 2010 (EP) 10191175.8

(51) Int. Cl. B01F 5/06

(52) U.S. Cl. CPC B01F 5/0602
USPC 366/337; 366/336

(57) ABSTRACT

Provided is a mixing apparatus which can efficiently mix two fluids, for example to create emulsions, which using a relatively low energy input. This objective is met by a mixing device comprising two confronting surfaces (1, 2) having cavities (3, 4) in the surfaces, (1, 2) and wherein the two confronting surfaces are located such that a least three narrow slits (cf. 7, 8, 81) are formed to provide subsequent contraction and expansion of the flow. Especially when the apparatus is run in a static mode, only a low energy input is required, while still providing favourable mixing conditions.

The present invention relates to a mixing apparatus for fluids and in particular, to flexible mixing devices which can provide a range of mixing conditions. The invention further relates to a method for mixing fluids.

A large number of intermediates and products are or include or are derived from dispersions. The term ‘dispersions’ is used to describe compositions which are characterised by at least two mutually immiscible phases, wherein at least one of the phases is dispersed in discrete droplets in the continuous second phase. Examples of such dispersions are water-in-oil emulsions and oil-in-water emulsions, which are important structures in food products and intermediates. In these cases both phases are fluid-like. For example butter and margarine are water-in-oil emulsions, while dressings and many dairy products like milk, yoghurt, and cream are oil-in-water emulsions. Importantly, the properties of dispersions are often dependent upon the mean size, aspect ratio and/or size distribution of the dispersed phase, and control of these parameters is dependent upon the dispersion process. The term ‘dispersion process’ is used to describe the process whereby the ingredients which comprise the dispersion are spatially arranged.

Critical to the dispersion process is the creation of interfacial surfaces, where the term ‘interfacial surfaces’ is used to describe the surfaces which define the boundaries between the dispersed phase and the continuous phase. Such creation is dependent upon certain detailed features of the process and, in particular, the modes, rates and times of mixing of the composition by, for example, the application of shear and/or extensional forces, and the consequent physical responses of the phases to the forces during the process. Such mixing is described as ‘dispersive mixing’. The efficiency of such mixing is dependent upon the apparatus employed and, more particularly, the ability of such apparatus to generate prescribed stresses within the dispersion in a controlled and uniform manner.

Mixing can be described as either distributive or dispersive. In a multi-phase material comprising discrete domains of each phase, distributive mixing seeks to change the relative spatial positions of the domains of each phase, whereas dispersive mixing seeks to overcome cohesive forces to alter the size and size distribution of the domains of each phase. Most mixers employ a combination of distributive or dispersive mixing, the balance between the two being determined by the intended application. For example, an ideal machine for mixing peanuts and raisins would be a wholly distributive mixer so as not to damage the things being mixed. Such machines are often referred to as blenders. For reducing the droplet size of an emulsion, on the other hand, dispersive mixing is the more important mixing mechanism, and the preferred machines often being referred to as homogenisers.

High pressure homogenisers are often used, for example in the dairy industry, to mix fluids and homogenise them, or to emulsify oil in water or water in oil to make a finely distributed emulsion. Several developments have taken place which try to overcome one or more of the problems of high pressure homogenisers. EP 0 194 812 A2 discloses a cavity transfer mixer or ‘CTM’, comprising a hollow cylindrical stator member and a cylindrical rotor member for rotation within the stator, the facing cylindrical surfaces of the rotor and stator carrying respective pluralities of parallel, circumferentially extending rows of cavities.

WO 96/20270 discloses a dynamic mixing apparatus for liquids, comprising closely spaced relatively moveable confronting surfaces each having a series of cavities therein, in which the cavities on each surface are arranged such that, in use, the cross-sectional area for flow of the liquid successively increases and decreases. This apparatus can be used to induce extensional flow in a liquid composition, and the cavities are arranged on the relevant surfaces such that shear is applied to the liquid as it flows between the surfaces. That apparatus is referred to as a ‘controlled deformation dynamic mixer’ (CDDM) and is distinguished from the CTM in that material is also subjected to extensional deformation. Extensional flow and efficient dispersive mixing is secured by having confronting surfaces with cavities arranged such that the cross sectional area for bulk flow of the liquid through the mixer successively increases and decreases by a factor of at least 5 through the apparatus. The CDDM combines the distributive mixing performance of the CTM with dispersive mixing performance.

U.S. Pat. No. 6,468,578 B1 discloses the use of a cavity transfer mixer for creating an emulsion of water droplets in a continuous fat phase.

Now CDDMs of conventional design rely upon the relative movement of their confronting surfaces in a direction which is orthogonal to the bulk flow. Such devices are typically configured as concentric cylinders or coaxial plates, in which cases the relative motions may be described as rotational.

Conventional CDDMs have been shown to provide means for dispersive mixing. However the efficacy of such means is dependent upon the spacing between the confronting surfaces in the regions of extensional flows, and there are constraints on such spacing. For example, in the case of a device configured as a concentric cylinder device in which the spacing is radial, then as the device is operated the resultant heating of the device may cause the rotor/drum to expand in a radial direction. The stator/sleeve may expand less as it is better able to lose heat. This can result in a narrowing of the gap between the confronting surfaces and even contact. At high operating speeds, contact between the surfaces can be catastrophic for the apparatus.

Further difficulties arise from the high shear rates which are encountered in mixers with very closely confronting surfaces. High shear rates lead to high shear stress (which is a function of shear rate and viscosity). These shear stresses lead to a high torque (which is related to the shear stress for a given geometry). For a fixed angular velocity of the mixing elements the power consumption is directly related to the torque. Hence mixers which employ high shear rates typically require large power inputs. This is not only expensive, but can produce unwanted heating of the material being processed.

Hence a dispersive mixing apparatus without rapid relative motion between parts such as experienced in CDDMs of conventional design would be advantageous, because such rapidly moving parts may lead to dimensional instabilities, unwanted wear of the machinery, high power input, and require safety measures in order to prevent breakage of the equipment.

Additionally small passages in CDDM type of mixer may lead to high pressures pumps being needed to pass fluids through the mixer. This usually is associated with high costs for pressure generation and high specific energy consumptions and temperature rises. Developments which may lead to reduction of such pressure drops would provide a significant advantage over current devices of that class.

EP 1 930 069 A1 discloses a static mixer for mixing two or more gaseous or liquid streams. The apparatus discloses a series of annuli through which fluids are pumped to effect mixing. The spaces of the annuli are between 0.25 and 1 millimeter, preferably between 0.6 and 0.7 millimeter.

US 2006/0051448 A1 discloses a flexible mixing tube wherein the fluid flowing through the tube experiences multiple contractions and expansions due to varying diameter of the tube. Similarly US 2004/0130062 A1 discloses a mixing device for use in an injection moulding apparatus.

US 2007/0041266 A1 discloses a cavitation mixing device for fluids to create a homogeneous mixture. Also US 2003/0147303 A1 discloses a cavitation mixer. U.S. Pat. No. 4,313,909 discloses a mixer for producing a reaction mixture for forming solid or cellular materials from flowable reactants. The mixer contains an annular flow space which may contain multiple contractions and expansions for the flow.

US 2003/0142582 A1 discloses an extensional flow mixer wherein the fluid experiences various contractions and expansions, as the fluid is forced to flow through slits which decrease in cross-sectional area in the flow direction. The device contains a mandrel which may rotate to provide additional shear mixing. The gaps which are used are normally between 0 and 4 millimeters.

U.S. Pat. No. 6,354,729 discloses a dynamic mixing device with integrated external means for pressure generation.

WO 2010/089320 A1, WO 2010/089322 A1, and WO 2010/091983 A1 disclose specific types of a distributive and dispersive mixing apparatus of the CDDM type or CTM type, comprising two confronting surfaces having cavities therein. These specific types may be used for the treatment of emulsions.

As stated in the foregoing, WO 96/20270 discloses a dynamic mixing apparatus for the dispersive mixing of liquids, in which dispersive mixing results from the passage of said liquids between closely spaced relatively moveable confronting surfaces.

### SUMMARY OF THE INVENTION

Consequently, in spite of the advances made in the prior art, there is a need to introduce mixing devices which (i) are able to effect specified dispersive and distributive mixing operations without requiring high operating pressures or rotational speeds, hence with lower energy input; (ii) can be designed for operation at any scale of manufacture without requiring the scale-up approach of ‘numbering up’ or ‘massively parallel’ manufacture; and (iii) reduce capital costs and facilitate deployment and maintenance through mechanical simplification.

We have now developed a mixing device comprising two confronting surfaces having cavities in the surfaces, and wherein the two confronting surfaces are located such that at least three narrow slits are formed, to provide subsequent contraction and expansion of the flow to effect the mixing of the fluids. The slits have a height between 3 micrometers and 300 micrometers, while the cavities are positioned such that a length in the direction of bulk flow is created (length 8 in FIG. 1) which is maximally 10 times larger than the height of the slit (distance 7 in FIG. 1). Alternatively the cavities are positioned such that a negative length (offset distance) is created (length 81 in FIG. 2), which is maximally 600 micrometers. The fluids are pressed through the slits and subsequently expand in a wider cavity. Effective dispersive mixing can be achieved, under relatively low pressure drop, leading to the formation of very fine emulsions, where the droplet size of the dispersed phase is small. This mixing device can be operated in a static mode or in a dynamic mode, meaning that the one of the confronting surfaces moves relative to the other surface in a direction perpendicular to the bulk flow. Especially the static mode has the advantage that relatively low power input is required, while still good and efficient mixing of at least two fluids is obtained. Moreover the pressure distribution across the length in bulk flow direction of the apparatus is rather even, when compared to some of the static mixers of the prior art.

By the static operation, effective mixing is achieved, under relatively low pressure, while still obtaining good mixing conditions as evidenced by the droplet size of a dispersed phase in an emulsion. Such a static mixer may provide similar dispersive mixing performance to a conventional high pressure homogeniser at a much lower operating pressure. Two fluids can be efficiently mixed using a small pressure drop in a mixing apparatus containing two confronting surfaces, wherein the two surfaces contain cavities, and wherein the cavities are arranged such that the cross-sectional area for flow of the liquid available during passage through the apparatus successively increases and decreases by a factor of at least 3.

Accordingly in a first aspect the present invention provides an apparatus for mixing at least two fluids, wherein the apparatus comprises two confronting surfaces 1, 2, spaced by a distance 7,

wherein the first surface 1 contains at least three cavities 3, wherein at least one of the cavities has a depth 9 relative to the surface 1,
wherein the second surface 2 contains at least three cavities 4 wherein at least one of the cavities has a depth 10 relative to the surface 2,
wherein the cross-sectional area for flow of the liquid available during passage through the apparatus successively increases and decreases at least 3 times, and
wherein the surface 1 has a length 5 between two cavities, and
wherein the surface 2 has a length 6 between two cavities, and
wherein the surfaces 1, 2 are positioned such that the corresponding lengths 5, 6 overlap to create a slit having a length 8 or do not overlap creating a length 81,
wherein the cavities are arranged such that the cross-sectional area for flow of the liquid available during passage through the apparatus successively increases in the cavities and decreases in the slits by a factor of at least 3, and
wherein the distance 7 between the two surfaces 1,2 is between 3 micrometer and 300 micrometer, and wherein
either the ratio between the length 8 and the distance 7 between the two surfaces 1, 2 ranges from 0 to 10,
or wherein the length 81 of overlap between the two surfaces 1, 2 is less than 600 micrometers.

In a second aspect the present invention provides a method for mixing at least two fluids to create a mixture of the at least two fluids, wherein the at least two fluids are brought into contact in an apparatus according to the first aspect of the invention.

### DESCRIPTION OF FIGURES

FIG. 1: Schematic representation of a preferred embodiment of the apparatus according to the invention, cross-sectional view (direction of bulk flow preferably from left to right).

FIG. 2: Schematic representation of a preferred embodiment of the apparatus according to the invention, cross-sectional view (direction of bulk flow preferably from left to right).

FIG. 3: Schematic representation of a preferred embodiment of the apparatus according to the invention, top view of one surface (direction of bulk flow preferably from left to right).

FIG. 4: Schematic representation of a preferred embodiment of the apparatus according to the invention, cross-sectional view (direction of bulk flow preferably from left to right).

FIG. 5: Schematic representation of a preferred embodiment of the apparatus according to the invention, cross-sectional view (direction of bulk flow preferably from left to right).

FIG. 6: Schematic representation of a preferred embodiment of the apparatus according to the invention, top view of one surface (direction of bulk flow preferably from left to right).

FIG. 7: Schematic representation of a preferred embodiment of the apparatus according to the invention, top view of one surface (direction of bulk flow preferably from left to right).

FIG. 8: Two-dimensional schematic representation of the inner geometry of the static version of the UMPF in its base position, cross-sectional view. Flow direction from left to right; 1 is top plate, 2 is bottom plate, 3 are the restrictions to the bulk flow, 4 are cavities. The bottom plate can slide to define various displacements:
A: indicates displacement of −2.7 mm
B: indicates displacement of −3 mm
C: indicates displacement of −4 mm
D: indicates displacement of −5 mm

FIG. 9: Channel height plot of mixing device, with a displacement of −4 millimeter. The displacement is described as the distance the top plate (only cavities) is moved in flow direction with respect to the bottom plate (cavities and restrictions), as described in example 1. Areas were the channel height is less than 0.05 millimeter are plotted black; the channel height at the white areas varies from 0.25 to 4 millimeter. Flow direction is from left to right, as indicated by arrows.

FIG. 10: Channel height plot of mixing device, with a displacement of −3 millimeter. The displacement is described as the distance the top plate (only cavities) is moved in flow direction with respect to the bottom plate (cavities and restrictions), as described in example 1. Areas were the channel height is less than 0.05 millimeter are plotted black; the channel height at the white areas varies from 0.25 to 4 millimeter. Flow direction is from left to right, as indicated by arrows.

Upper plot shows the entire mixing device, lower plot shows a detail of the centre of the mixing device.

FIG. 11: Channel height plot of mixing device, with a displacement of −2.7 millimeter. The displacement is described as the distance the top plate (only cavities) is moved in flow direction with respect to the bottom plate (cavities and restrictions), as described in example 1. Areas were the channel height is less than 0.05 millimeter are plotted black; the channel height at the white areas varies from 0.25 to 4 millimeter. Flow direction is from left to right, as indicated by arrows.

Upper plot shows the entire mixing device. The lower plot shows a contour plot for a detail of the centre of the mixing device at this displacement. The curves marked with ‘1’ show a height of 0.01 millimeter (distance between two surfaces), the curves marked with ‘2’ show a height of 0.05 millimeter.

FIG. 12: Average size of sunflower oil droplets emulsified in water, at various rotational speeds in an apparatus according to the invention (see example 2); and at two flow rates of an emulsion (20 milliliter per second (squares ▪), and 40 milliliter per second (diamond ♦)).

### DETAILED DESCRIPTION

Unless defined otherwise, all technical and scientific terms used herein have the same meaning as commonly understood by one of ordinary skill in the art.

All percentages, unless otherwise stated, refer to the percentage by weight.

In case a range is given in the context of the present invention, the indicated range includes the mentioned endpoints.

The average size of the dispersed phase in an emulsion is generally expressed as the d_{3,2} value, which is the diameter of a sphere that has the same volume/surface area ratio as the measured particles (unless indicated otherwise).

### Apparatus for Mixing

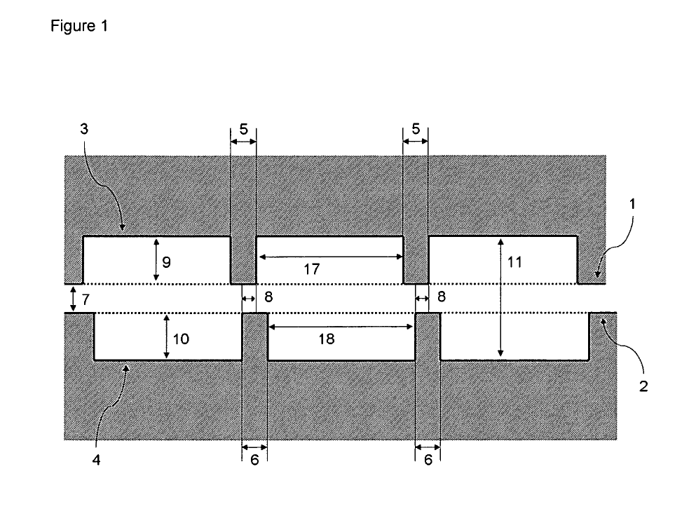

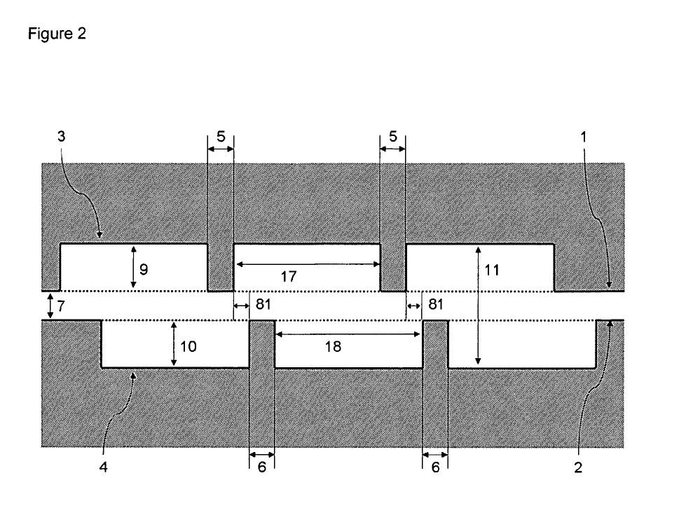

With reference to FIG. 1 and FIG. 2, in a first aspect the present invention provides an apparatus for mixing at least two fluids, wherein the apparatus comprises two confronting surfaces 1, 2, spaced by a distance 7,

wherein the first surface 1 contains at least three cavities 3, wherein at least one of the cavities has a depth 9 relative to the surface 1,
wherein the second surface 2 contains at least three cavities 4 wherein at least one of the cavities has a depth 10 relative to the surface 2,
wherein the cross-sectional area for flow of the liquid available during passage through the apparatus successively increases and decreases at least 3 times, and
wherein the surface 1 has a length 5 between two cavities, and
wherein the surface 2 has a length 6 between two cavities, and
wherein the surfaces 1, 2 are positioned such that the corresponding lengths 5, 6 overlap to create a slit having a length 8 or do not overlap creating a length 81,
wherein the cavities are arranged such that the cross-sectional area for flow of the liquid available during passage through the apparatus successively increases in the cavities and decreases in the slits by a factor of at least 3, and
wherein the distance 7 between the two surfaces 1,2 is between 3 micrometer and 300 micrometer, and wherein
either the ratio between the length 8 and the distance 7 between the two surfaces 1, 2 ranges from 0 to 10,
or wherein the length 81 of overlap between the two surfaces 1, 2 is less than 600 micrometers.

The surfaces 1 and 2 that each contain at least three cavities 3, 4 create a volume between the surfaces for flow of the two fluids which are mixed. The cavities in the surface effectively increase the surface area available for flow. Due to the presence of the cavities, the small area for flow between the surfaces 1 and 2 can be considered to be a slit having a height 7. The distance 5 between two cavities in surface 1 and distance 6 between two cavities in surface 2 and the relative position of these corresponding parts determine the maximum length of the slit.

With reference to FIG. 1 and FIG. 2, the fluids flow from left to right through the apparatus. The slits create an acceleration of the flow, while at the exit of the slit the fluids decelerate due to the increase of the surface area for flow and the expansion which occurs. The acceleration and deceleration leads to the break up of the large droplets of the dispersed phase, to create finely dispersed droplets in a continuous phase. The droplets which are already small, remain relatively untouched. The flow in the cavities is such that the droplets of the dispersed phase eventually become evenly distributed in the continuous phase.

The cross-sectional area for flow of the liquid available during passage through the apparatus successively increases and decreases at least 3 times, and these passages lead to effective mixing of the two fluids. This means that the cross-sectional area for flow of liquid in the cavities is at least 3 times larger than the cross-sectional area for flow of liquid in the slits. This relates to the ratio between lengths or distances 11 and 7. Preferably the cross-sectional area for flow is designed such that the cross-sectional area for flow of the liquid available during passage through the apparatus successively increases and decreases by a factor of at least 5, preferably at least 10, preferably at least 25, preferably at least 50, up to preferred values of 100 to 400. The cross-sectional surface area for flow of the fluids is determined by the depth 9 of the cavities 3 in the first surface 1 and by the depth 10 of the cavities 4 in the second surface 2. The total cross-sectional area is determined by the length 11 between the bottoms of two corresponding cavities in the opposite surfaces.

The surfaces 1, 2 each contain at least three cavities 3, 4. In that case the flow expands at least 3 times during passage, and the flow passes through at least 3 slits during the passage. Preferably the cross-sectional area for flow of the liquid available during passage through the apparatus successively increases and decreases between 4 and 8 times. This means that the flow during passage experiences the presence of between 4 and 8 slits and cavities.

The distance 7 between the corresponding surfaces is between 3 micrometers and 300 micrometers (including the endpoints of the range), which corresponds to the height of the slit. Preferably the distance 7 is between 3 micrometer and 200 micrometer, preferably between 5 micrometer and 150 micrometer, preferably between 5 micrometer and 100 micrometer, preferably between 5 micrometer and 80 micrometer, preferably between 5 and 60 micrometer, preferably between 5 micrometer and 40 micrometer. More preferably the distance 7 is between 8 micrometer and 40 micrometer, more preferably between 8 micrometer and 30 micrometer, more preferably between 10 micrometer and 30 micrometer, more preferably between 10 micrometer and 25 micrometer, more preferably between 15 micrometer and 25 micrometer.

The actual height of the slit (distance 7) depends on the dimensions of the apparatus and the required flow rate, and the skilled person will know how to design the apparatus such that the shear rates within the apparatus remain relatively constant irrespective of the size of the apparatus.

The two surfaces 1, 2 with cavities that together form the volume for the flow of the at least two fluids are positioned such that the corresponding lengths 5, 6 of the surfaces (that create the slit overlap) create a length 8 of the slit (in the direction of the bulk flow) which is maximally 10 times as large as the distance 7 between the surfaces. The ‘length 8’ could also be called ‘offset distance 8’, indicating that the two surfaces 1, 2 can be positioned such that length or offset distance 8 can be adjusted. Preferably the ratio between the length 8 and the distance 7 between the two surfaces 1, 2 ranges from 0 to 5. Most preferably the ratio between the length 8 and the distance 7 ranges from 0 to 1. As an example, when the ratio between length 8 and distance 7 is 5, and the distance 7 between the two surfaces 1, 2 is 15 micrometer, then the length 8 of the slit is 75 micrometer.

Alternatively the surfaces 1, 2 are positioned such that no overlap is created, however in that case a length 81 is created which is maximally 600 micrometers. The ‘length 81’ could also be called ‘offset distance 81’, indicating that the two surfaces 1, 2 can be positioned such that length or offset distance 81 can be adjusted. Preferably the length 81 is 300 micrometer or less. In that case there is no overlap between the corresponding parts of the surfaces, and the slit is created with what could be called a ‘negative overlap’. This ‘negative overlap’ accommodates the possibility of near zero distance 7 between the two corresponding surfaces 1 and 2. Preferably the length 81 is such, that the ratio between the length 81 and the distance 7 between the two surfaces 1, 2 ranges from 0 to 30, more preferred from 0 to 15, more preferred from 0 to 10, more preferably from 0 to 5 and most preferably from 0 to 2. Most preferably the ratio between the length 81 and the distance 7 ranges from 0 to 1. As an example, when the ratio between length 81 and distance 7 is 2, and the distance 7 between the two surfaces 1, 2 is 15 micrometer, then length 81 (or what could be called negative overlap) is 30 micrometer.

The little overlap between the corresponding parts of the surfaces 1, 2 leads to a relatively small pressure that is required in order to create a fine dispersion, as compared to apparatuses which have a longer overlap and consequently also need a higher pressure. Usually a longer distance of a slit (or longer capillary) leads to smaller droplets of the dispersed phase. Now we found that with a short capillary or even without capillary the droplets of the dispersed phase remains small, while the pressure required is relative low, as compared to a longer overlap.

Advantageously the negative overlap leads to smaller oil droplets in an emulsion as compared to the same system operated at the same pressure drop, and with a positive overlap (meaning that length 8 in FIG. 1 is larger than 0). If the mixing device with a negative overlap is operated at the same pressure drop as a mixing device with a positive overlap, then the flow rate of the emulsion can be higher, due to less resistance to flow, while the dispersing capability is similar or even improved (average droplet size of the dispersed phase is at least equal to or smaller than the comparable system with positive overlap).

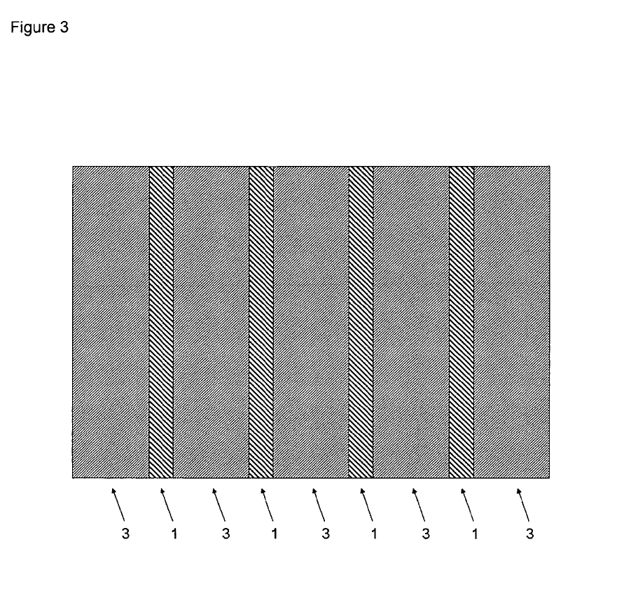

With reference to FIG. 1, FIG. 2, and FIG. 3 in a preferred embodiment the shape of the cavities 3, 4 is rectangular when seen from the side (cross-section) like in FIG. 1, FIG. 2 or from the top as in FIG. 3. Preferably the cavities 3 of surface 1 all have the same depth 9 relative to the surface 1. Preferably the cavities 4 of surface 2 all have the same depth 10 relative to the surface 2. The cavities 3 in surface 1 have a length 17, and preferably all cavities 3 have the same length 17. The cavities 4 in surface 2 have a length 18, and preferably all cavities 4 have the same length 18.

Alternatively the shape of the cavities 3 may take any other form, for example the cross-section may not be rectangular, but may take the shape of for example a trapezoid, or a parallelogram, or a rectangle where the corners are rounded.

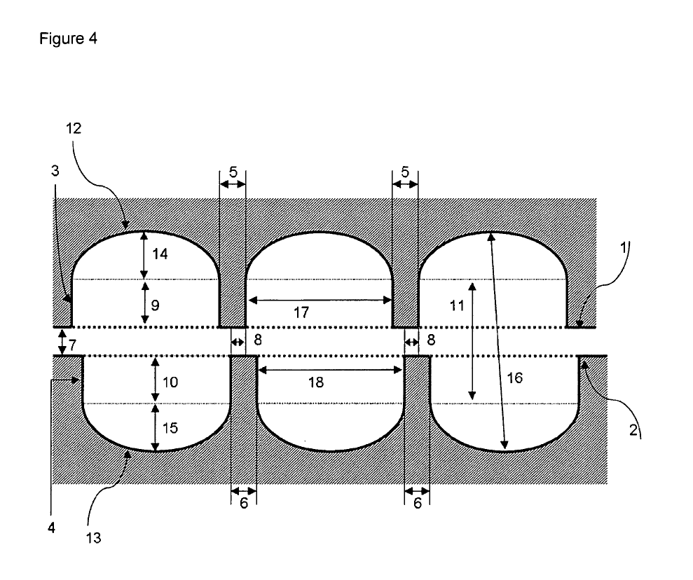

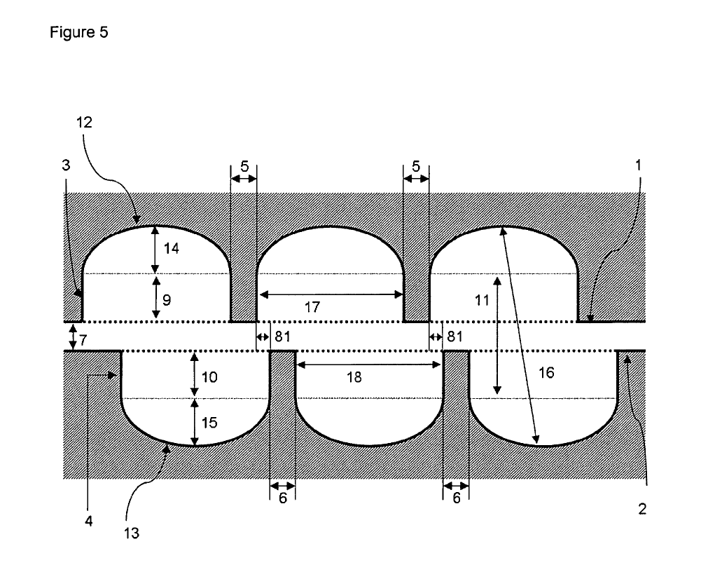

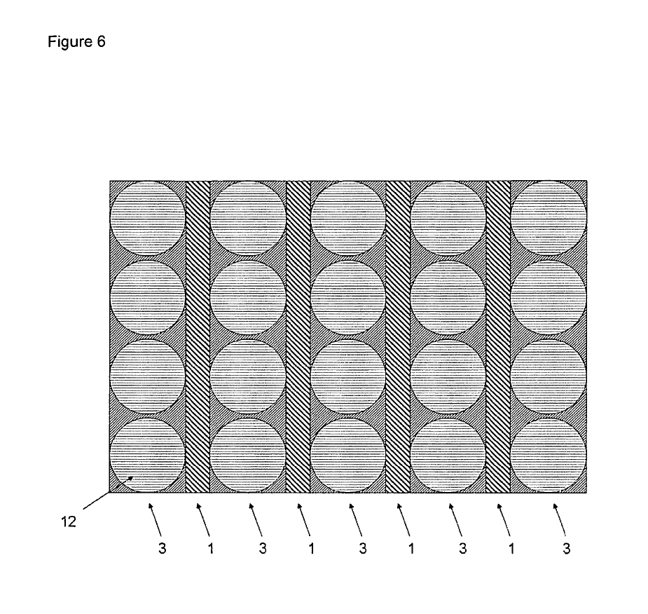

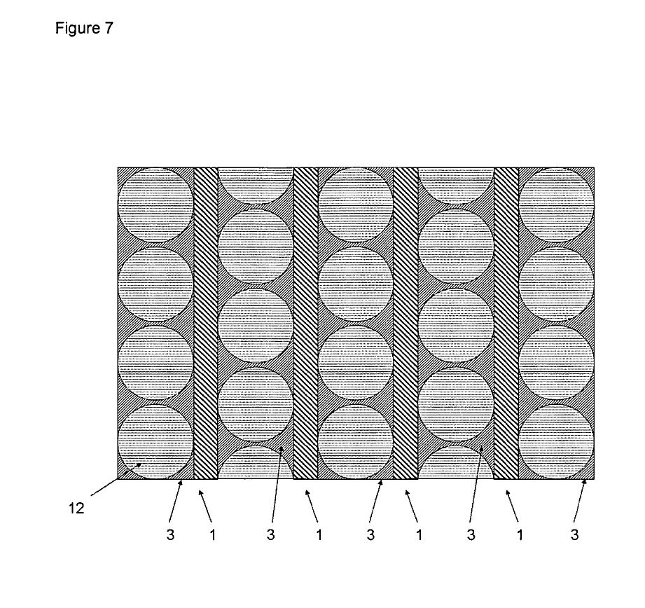

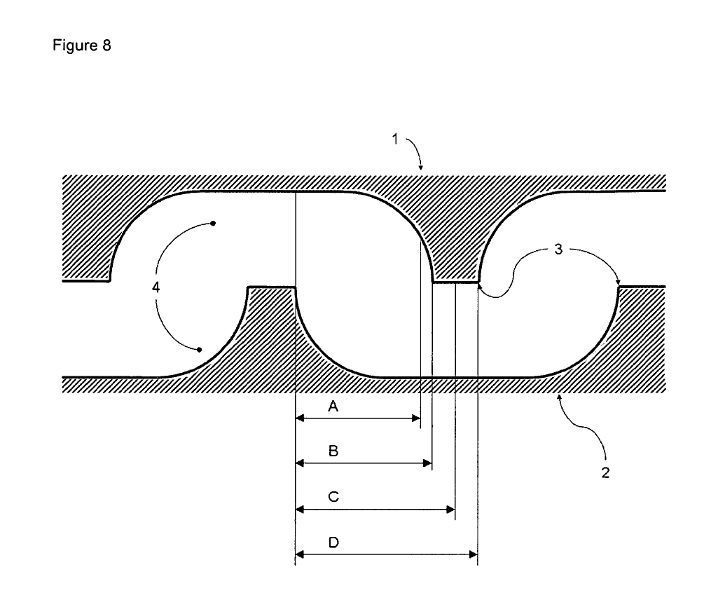

Preferably the apparatus according to the invention additionally comprises one or more cavities 12 and/or one or more cavities 13. Preferably the cavities 3 and 4 contain cavities 12, 13, as schematically depicted in FIG. 4, FIG. 5, FIG. 6, and FIG. 7. These optional cavities increase the cross-sectional area for flow of the fluids. They may be arranged as indicated in FIG. 6, or alternatively may also be arranged as indicated in FIG. 7. Any other arrangement of the cavities and the number of cavities and size of the cavities may be within the scope of the present invention. The cavities may have a circular shape when seen from above (as indicated in FIG. 6 and FIG. 7). They also may have an oval shape when seen from above, or a square shape, or any other suitable shape. The largest dimension of the cavities 12, 13 is preferably equal to the length 17, 18 of the cavities 3, 4.

The optional cavities 12 preferably have a depth 14, and preferably all cavities 12 have the same depth 14. The cavities 13 preferably have a depth 15, and preferably all cavities 13 have the same depth 15. The total cross-sectional surface area for flow of the fluids is determined by the distance 16. Preferably the bottom of the cavities 12, 13 has a concave shape, although any other shape may be possible as well.

We have now determined that it is possible to configure the cavities on the confronting surfaces in the mixing device according to the invention such that the required pressure to effect the passage of liquids between the confronting surfaces may be considerably reduced. In particular, we have determined that by offsetting at least one chain or ring of cavities with respect to a successive or preceding ring of cavities in the same surface, then it is possible to reduce the operating pressure drop without loss of mixing performance (compare FIG. 6 and FIG. 7).

The apparatus according to the invention may be designed as a flat apparatus, and preferably the surfaces 1, 2 are substantially parallel flat surfaces, such that the distance 7 between the surfaces is equal across the length of the apparatus (naturally with the exception of the cavities). ‘Substantially parallel’ is to be understood that the apparatus is designed such that the surfaces 1 and 2 are parallel in the direction of bulk flow. In practice the surfaces may be slightly deviating from parallel position, because of manufacturing tolerances. The dimensions of the apparatus though indicate that this possible deviation is maximally in the order of magnitude of micrometers. Most preferred the surfaces 1, 2 are parallel surfaces in the direction of bulk flow. FIG. 3 discloses a schematic representation of a preferred embodiment of the apparatus according to the invention. It shows the top view onto the first surface 1 creating slits, and cavities 3. With reference to FIG. 3, the bulk flow of the liquid is from left to right. The slits and cavities extend across the entire width of the surface 1 and are preferably located substantially perpendicular to the direction of the bulk flow. ‘Substantially perpendicular’ is to be understood that the apparatus is designed such that the slits and cavities are located perpendicular to the direction of the bulk flow. In practice the slits and cavities may be slightly deviating from this position, because of manufacturing tolerances. The dimensions of the apparatus though indicate that this possible deviation is maximally in the order of magnitude of micrometers. Most preferred the slits and cavities extend across the entire width of the surface 1 and are located perpendicular to the direction of the bulk flow.

Alternatively, in another preferred embodiment the two confronting surfaces 1, 2 are shaped and arranged as co-axial surfaces. In a preferred embodiment one of the surfaces is the outer surface of a cylinder-shaped device, which is able to rotate relative to the other surface. This other surface then is the inner surface of a cylinder-shaped device, and these two cylinders share a central axis that is located parallel to the direction of the bulk flow. Hence preferably one of the surfaces is able to rotate relative to the other surface, and wherein the rotation is perpendicular to the direction of the bulk flow. This rotation may involve that both surfaces rotate, as long as the surfaces rotate relative to each other.

The preferred device may be operated both in static mode (no rotation), as well as dynamic (with rotation). In that case preferably one of the surfaces is able to rotate relative to the other surface at a frequency between 10 and 40,000 rotations per minute, preferably between 20 and 35,000 rotations per minute, more preferably between 1,000 and 25,000 rotations per minute.

In general rotation may lead to improved mixing process and creation of smaller dispersed phase droplets. Static operation has the advantage that less energy is required for mixing. Operation of the device without rotation leads to very efficient and effective mixing of fluids. Without rotation similar dispersed phase sizes can be obtained, without requirement of high pressure or use of energy for rotation. On the other hand rotation at high frequencies may lead to very finely dispersed droplets of the dispersed phase in case two fluids are mixed to create an emulsion.

In case of the cylinder shaped configuration, FIG. 3, FIG. 6, and FIG. 7 can be considered to be the surface of a cylinder which as if layed out on a flat surface. The upper edge in this figure will in practice be connected to the lower edge to form a circular surface.

In the preferred cylinder shape, the apparatus according to the invention forms a controlled deformation dynamic mixer (CDDM), wherein the surfaces 1, 2 have been positioned such that the slits have only a very small overlap.

In a preferred example, the dimensions of such a CDDM apparatus according to the invention are such that the distance between the two surfaces 7 is between 10 and 20 micrometer; and/or wherein the length of the slit 8 is maximally 2 millimeter, for example 80 micrometer, or 20 micrometer, or even 0 micrometer. The length of the slit 8 plus the length of the cavity 17, 18 combined is maximally 10 millimeter; and/or wherein the depth of the cavities 9, 10 is maximally 2 millimeter. In that case preferably the internal diameter of the outer surface is between 20 and 30 millimeter, preferably about 25 millimeter. The total length of the apparatus in that case is between 7 and 13 centimeter, preferably about 10 centimeter. The length means that this is the zone where the fluids are mixed. The rotational speed of such a preferred apparatus is preferably 0 (static), or alternatively between 5,000 and 25,000 rotations per minute.

The shape of the area for liquid flow may take different forms, and naturally depends on the shape of the confronting surfaces. If the surfaces are flat, then the cross-sectional area for flow may be rectangular. The two confronting surfaces may also be in a circular shape, for example a cylindrical rotor which is positioned in the centre of a cylindrical pipe, wherein the outside of the cylindrical rotor forms a surface, and the inner surface of the cylindrical pipe forms the other surface. The circular annulus between the two confronting surface is available for liquid flow. The confronting surfaces may also be in the form of bent surfaces, e.g. in the shape of an oval, such that the annular space between the surfaces is not circular but oval.

### Method for Mixing

The apparatus according to the invention can be used for mixing two fluids. Hence in a second aspect the present invention provides a method for mixing at least two fluids to create a mixture of the at least two fluids, wherein the at least two fluids are brought into contact in an apparatus according to the first aspect of the invention.

The apparatus can be run in static mode, for example when the surfaces 1, 2 are substantially flat, or when they are arranged as concentric cylinders (as explained herein before). Alternatively this method can be applied in dynamic mode, when the surfaces 1, 2 are arranged as concentric cylinders (as explained herein before).

Advantageously the pressure required to obtain efficient mixing is relatively low, which leads to reduction of energy use, while still obtaining a good mixing of the fluids. For example a high pressure homogeniser often operates at pressure up to 300 bar or even higher. Preferably the apparatus according to the invention is operated at a pressure less than 200 bar, when mixing two fluids, preferably less than 80 bar, preferably less than 60 bar, preferably less than 40 bar, most preferred less than 30 bar. With these relatively low pressures a good mixing process is obtained, also in static mode.

The fluids may be liquid, gel or dispersion compositions. Prior to being mixed in the apparatus according to the invention, the fluids may be premixed, in order to improve the dispersibility of the phases.

The apparatus according to the invention may be used to create a water-in-oil or an oil-in-water emulsion. Hence preferably the method according to the invention is for the production of an emulsion, wherein the at least two fluids comprise at least one hydrophobic fluid, and at least one hydrophilic fluid. Efficient mixing can be obtained, leading to small droplet size of the oil dispersed in a continuous aqueous phase, or aqueous phase droplets dispersed in a continuous oil phase. This may leading to reduced requirement of emulsifier. Preferably the average size of the dispersed phase is less than 10 micrometer, preferably less than 8 micrometer, preferably less than 6 micrometer. More preferred, the average droplet size of the dispersed phase is less than 4 micrometer, or even less than 2 micrometer.

The hydrophilic liquid preferably is an aqueous phase. The hydrophobic fluid preferably may be a lipid compound, such as an edible oil from vegetable or animal origin. In here, an edible oil also encompasses edible fats; oils in general are fluid at room temperature, while fats generally are solid at room temperature. Examples of edible oils from vegetable origin are sunflower oil, rapeseed oil, olive oil, palm oil. Examples of edible oils from animal origin are dairy fats such as butter oil, or fish oil. In case the edible oil is not liquid at room temperature, the oil may need to be heated in order to liquidy the oil, and subsequently mix it with an aqueous phase. Other preferred lipid compounds are lecithin, fatty acid, monoglyceride, diglyceride, triglyceride, phytosterol, phytostanol, phytosteryl-fatty acid ester, phytostanyl-fatty acid ester, waxes, fatty alcohols, and fat-soluble vitamins (A, D, E, K). Other suitable lipid compounds may be hydrophobic compounds like the carotenoids (e.g. alpha-carotene, beta-carotene, lycopene, lutein, zeaxanthin). These lipids may be used to create edible emulsions.

Also hydrophobic materials like mineral oils, petrolatum, and silicon oils, and derivatives of these compounds are examples of hydrophobic compounds which can be used to create an emulsion.

The emulsions suitably contain an oil-in-water or a water-in-oil emulsifier, which are known in the art.

The apparatus can be used for preparing oil-in-water emulsions in which the concentration of dispersed hydrophobic phase is preferably less than 40% by weight, more preferred less than 20% by weight, more preferred less than 10% by weight. In that case the static operation leads to a small dispersed droplet size, which is similar to the operation of a mixer rotating at high speed (and consequently large power consumption for rotation).

Alternatively the apparatus according to the invention is particularly useful for creating oil-in-water emulsions having a relatively high dispersed phase content. Preferably in that case the dispersed hydrophobic phase is present at a concentration of at least 50% by weight, more preferred at least 60% by weight, more preferred at least 70% by weight, more preferred at least 80% by weight, and most preferred at least 90% by weight. Even more preferred the hydrophobic fluid preferably has a high dynamic viscosity, preferably between 1,000 mPa·s and 10,000,000 mPa·s, more preferred between 6,000 mPa·s and 10,000,000 mPa·s, most preferred between 10,000 mPa·s and 1,000,000 mPa·s. Hence preferably the method according to the second aspect of the invention is suitable for the production of an oil-in-water emulsion, wherein the concentration of the hydrophobic phase is at least 50% by weight, and wherein the dynamic viscosity of the hydrophobic phase is at least 1,000 mPa·s. In this case the hydrophobic phase is considered to be the oil phase.

Preferred aspects disclosed in connection with the first or second aspects of the present invention may also be applicable to the other aspect of the present invention, mutatis mutandis. The various features and embodiments of the present invention, referred to in individual sections below apply, as appropriate, to other sections, mutatis mutandis. Consequently features specified in one section may be combined with features specified in other sections, as appropriate. All publications mentioned in this specification are herein incorporated by reference. Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the claims.

### EXAMPLES

The following non-limiting examples illustrate the present invention.

### Example 1

### Flat Mixing Device

The following example describes a mixing device consisting of two corresponding flat panels, made from stainless steel. Both panels have a rectangular shape having a width of 130 millimeter and a length of 160 millimeter. Both panels contain cavities that have been made in its surfaces. These flat plates can be considered to be laid out versions of a rotor-stator device, wherein the rotor is a rotating axis having cavities inside a hollow cylinder which forms the stator.

FIG. 8 shows a schematic representation of part of the flat mixing device, as a vertical cross section. Flow direction is from left to right; 1 is top plate, 2 is bottom plate, 3 are the restrictions to the bulk flow, 4 are cavities. The bottom plate can slide relative to the top plate, to define various displacements of the bottom plate: A: indicates displacement of −2.7 mm; B: indicates displacement of −3 mm; C: indicates displacement of −4 mm; D: indicates displacement of −5 mm. Also the distance between the top plate and the bottom plate can be increased, as the bottom plate can be moved away from the top plate.

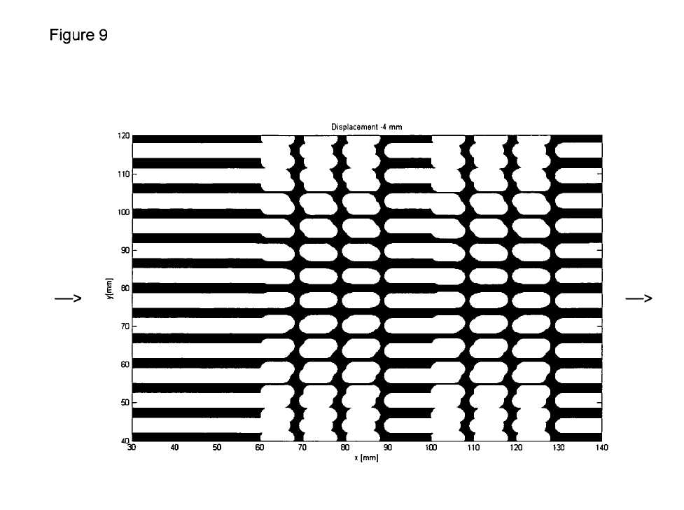

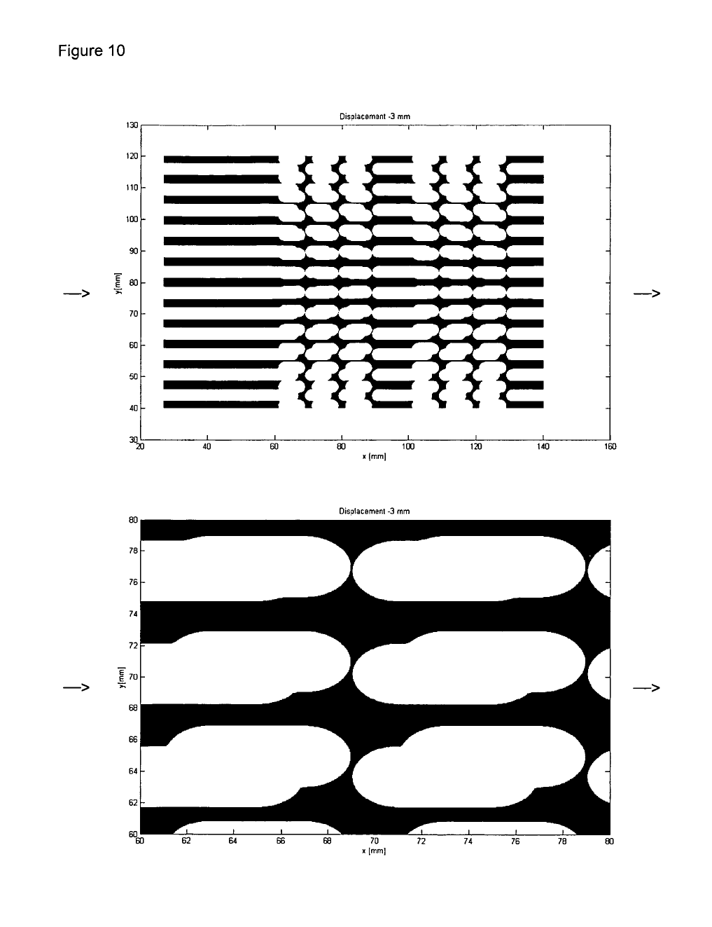

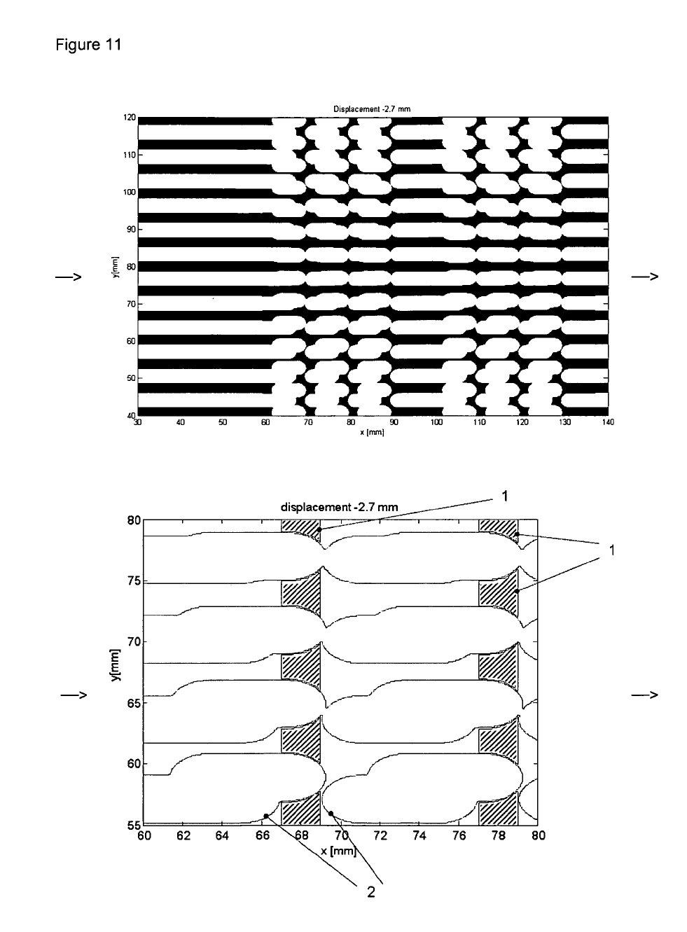

FIG. 9, FIG. 10, and FIG. 11 show representations of the profile of the cavities and slits with displacements of −4 millimeter (FIG. 9), −3 millimeter (FIG. 10), and −2.7 millimeter (FIG. 11). These figures show in vertical direction (y-axis) the width of the mixing device, and in horizontal direction (x-axis) the length of the mixing device (x-axis is the direction of bulk flow).

The cavities in the surfaces of the plates are half cylinders with a radius of 2 millimeter and a length of 4 millimeter, at the end of the cylinder a spherical cut-out is made with a radius of 2 millimeter. On the top plate (also referred to as stator) the cavities are spaced 2 millimeter in the x-direction (horizontal in FIG. 9, FIG. 10, and FIG. 11), and 2.04 millimeter in the y-direction (vertical in FIG. 9, FIG. 10, and FIG. 11). The bottom plate (also referred to as rotor) also contains these cavities. The cavities are spaced 2 millimeter in the x-direction (horizontal in FIG. 9, FIG. 10, and FIG. 11), and 2.54 millimeter in the y-direction (vertical in FIG. 9, FIG. 10, and FIG. 11).

The two panels are attached to each other, with the surfaces containing the cavities facing each other. This way a mixing device is created wherein fluids are introduced on one of the short sides of the rectangle, and the fluids are mixed in the interior, where the fluids experience expansions and contractions on their flow to the other short side of the rectangle. As the locations of the cavities in the two plates are not the same, the cavities create various flow paths when the two plates are connected to each other. At some locations the flow experiences a wide gap (where the cavities are located, indicated in white in FIG. 9, FIG. 10, and FIG. 11), while at other places there is no cavity and the flow experiences a constriction (indicated in black in FIG. 9, FIG. 10, and FIG. 11). The constrictions are formed by 3 as indicated in FIG. 8. The two panels can slide relative to each other, wherein the long sides remain aligned, and the short sides can be moved apart (in the plots in FIG. 9, FIG. 10, and FIG. 11 displacement from left to right). By this displacement the position of the cavities relative to each other can be manipulated, in order to create or remove restrictions for the flow, leading to various flow path configurations.

At a displacement of −4 millimeter the cavity rows are separated by a shallow slit (height 0.01 millimeter) with a varying length, having a length in x-direction of at least 1 millimeter, see FIG. 8, indicating a length of the slit in the direction of bulk flow of about 1 millimeter, and see plot FIG. 9. In this operational mode there are 6 slits with a height of 0.01 millimeter in which the flow is subjected to contraction, at about 70 mm, 80 mm, 90 mm, 110 mm, 120 mm, and 130 mm (black lines on horizontal x-axis, see FIG. 9; the length of the slits in x-direction is at least 1 millimeter). With reference to FIG. 1, in the present case distance 7 is 0.01 millimeter at the x-positions of about 70 mm, 80 mm, 90 mm, 110 mm, 120 mm, and 130 mm; and length 8 is at least 1 millimeter. Hence the ratio between length 8 and distance 7 is about 100.

At a displacement of −3 millimeter the centre row of cavities of the bottom plate are touching the cavities at the top plate. From FIG. 8 it follows that there is no overlap between the two corresponding restrictions to the flow, the restrictions 3 in FIG. 8 touch each other. See also plot FIG. 10 (overview and detail of centre). In this operational mode there are 6 slits with a height of 0.01 millimeter in which the flow is subjected to contraction, at about 70 mm, 80 mm, 90 mm, 110 mm, 120 mm, 130 mm (on horizontal x-axis, see FIG. 10). The height of the slit is 0.01 millimeter (distance 7 in FIG. 1) at the x-positions of about 70 mm, 80 mm, 90 mm, 110 mm, 120 mm, and 130 mm. As can be observed from the bottom FIG. 10, the cavities touch each other, hence the length of the slit (length 8 in FIG. 1) is very small, and this could be regarded to be a position wherein length 8 (in FIG. 1) is about 0. Hence the ratio between length 8 and distance 7 is about 0.

At a displacement of −2.7 millimeter the cavities of bottom and top plate overlap each other in the centre (still separated at the sides), see plots FIG. 11 (overview top and detail of centre bottom). From FIG. 8 it follows that there is no overlap between the two corresponding restrictions to the flow, actually a negative overlap is created: the restrictions 3 in FIG. 8 are about 0.3 mm apart from each other. The maximum negative overlap (length 81 in FIG. 2) is about 0.3 millimeter, hence the ratio between length 81 and distance 7 is maximally 30. The bottom plot of FIG. 10 shows a contour plot of the centre of the mixing device at this displacement of −2.7 millimeter. The curves and shaded areas marked with ‘1’ show where the height of the slit (distance 7) is 0.01 millimeter, which is the distance between the two surfaces (distance 7 in FIG. 1). At these two x-positions two straight slit are located with a height of 0.01 mm, and these two straight slits are interrupted by the cavities. Similar straight slits having a height of 0.01 mm are also located at the x-positions at about 90 mm, 110 mm, 120 mm, and 130 mm. The curves marked with ‘2’ show where the height is 0.05 millimeter, and inside these ‘bubble shapes’ (which are the projections of two cavities, one in the upper surface, and one in the lower surface, and that face each other) the height is more than 0.05 millimeter.

In order to investigate the effect of the slit height, four experiments were conducted, with 2 displacements (length 8 in FIG. 1, −4 millimeter as in FIG. 9, and −3 millimeter as in FIG. 10, respectively) and two channel heights (distance 7 in FIG. 1, 0.01 and 0.6 millimeter, respectively). In case the channel or slit height (distance 7) is 0.01 millimeter (10 micrometer) then the black areas in FIG. 9 and FIG. 10 at the x-positions of about 70 mm, 80 mm, 90 mm, 110 mm, 120 mm, and 130 mm have a height of 0.01 millimeter, and the white areas a depth ranging from 0.25 to 4 millimeter (each cavity has a maximal depth of 2 millimeter). In case the channel or slit height (distance 7) is 0.6 millimeter (600 micrometer) then the black areas in FIG. 9 and FIG. 10 at the x-positions of about 70 mm, 80 mm, 90 mm, 110 mm, 120 mm, and 130 mm have a height of [0.6+0.01] millimeter, and the white areas still have a depth ranging from 0.600+[0.25 to 4] millimeter.

TABLE 1
Description of 4 experiments in mixing device.

| | displacement | channel height |
|---|---|---|
| | (length 8 in FIG. 1) | (distance 7 in FIG. 1 or FIG. 2) |
| experiment | [millimeter] | [millimeter] |
| 1 | −4 | 0.01 |
| 2 | −4 | 0.6 |
| 3 | −3 | 0.01 |
| 4 | −3 | 0.6 |

The mixing device was used to create oil-in-water emulsions of the following model system:

| | |
|---|---|
| demineralised water: | 94.9% by weight |
| sunflower oil: | 5.0% by weight |
| pluronic o/w emulsifier: | 0.1% by weight |

A pre-emulsion of this system was made, and by means of a high pressure pump, the mixture was pumped through the mixing device, at a flow rate as indicated in the table below. Samples of the mixture are taken at 3 locations: sample 1 before the pump, sample 2 from within mixing device (after first contraction at about 70 millimeter in x-direction), sample 3 after the mixing device. The average diameter (Sauter mean diameter d_{3,2}) of the oil droplets has been determined at these 3 sampling points. Moreover the pressure drop over the mixing device is measured. This yields the following results.

TABLE 2
Results of 4 experiments in mixing device.

| | pressure | flow rate | d_{3, 2} | | |
|---|---|---|---|---|---|
| | drop | [gram | [micrometer] | | |
| exp. | [bar] | per sec] | sample 1 | sample 2 | sample 3 |
| 1 | 37.9 | 23.0 | 15.43 | 5.56 | 5.01 |
| 2 | 0.0 | 21.9 | 13.76 | 12.30 | 12.40 |
| 3 | 37.6 | 21.6 | 12.968 | 6.40 | 5.00 |
| 4 | 0.0 | 21.8 | 13.91 | 12.29 | 12.35 |

This example shows:

Experiments 1 and 3, where the slit height is 0.01 millimeter show break-up of the oil droplets, as shown by the d_{3,2} value after the first contraction at about 70 mm (x-direction), sample 2, and also at the end of the mixing device, sample 3. In both experiments 1 and 3 the obtained average droplet size (d_{3,2}) is about 5 micrometer. After the first contraction further break up of the droplets occurs (d_{3,2} of sample 3 is smaller than of sample 2).

When the slit height is 0.61 millimeter (experiments 2 and 4), the bubble droplet size hardly decreases in the mixing device, as is shown by the d_{3,2} values at samples 2 and 3. The mixing device is hardly functional in this case. The d_{3,2} of the samples 3 is not smaller than the samples 2.

In a next experiment 3 displacements (length 8 in FIG. 1 or length 81 in FIG. 2) were compared: −4 millimeter as in FIG. 9, −3 millimeter as in FIG. 10, −2.7 millimeter as in FIG. 11). The channel height (distance 7 in FIG. 1 and FIG. 2) was 0.01 millimeter (10 micrometer). Oil-in-water emulsions were made using the same raw materials as the previous experiment (5% sunflower oil in water and pluronic emulsifier).

Samples to determine the average droplet size (Sauter mean diameter d_{3,2}) were taken at four locations:

Sample 1a: premix emulsion
Sample 1b: premix, after pump and flow meter that pumps the emulsion into the flat mixing device
Sample 2: from within mixing device (after first contraction at about 70 millimeter in x-direction)
Sample 3: after the mixing device.

TABLE 3
Description of experiments in mixing device with various
displacements, and channel height 0.01 millimeter.

| displacement | | | | | | |
|---|---|---|---|---|---|---|
| (length 8 in FIG. | | | d_{3, 2} | | | |
| 1 or length 81 | pressure | flow rate | [micrometer] | | | |
| in FIG. 2) | drop | [gram | sam- | sam- | sam- | sam- |
| [millimeter] | [bar] | per sec] | ple 1a | ple 1b | ple 2 | ple 3 |
| −2.7 | 19.8 | 54.2 | 15.2 | 13.2 | 7.7 | 6.3 |
| | 29.9 | 71.6 | 12.9 | 12.2 | 9.1 | 5.0 |
| | 34.4 | 85.7 | 14.1 | 12.5 | 6.3 | 3.4 |
| −3 | 19.8 | 46.0 | 16.0 | 14.7 | 9.5 | 6.2 |
| | 33.7 | 75.7 | 13.9 | 13.2 | 7.9 | 4.5 |
| −4 | 24.1 | 32.0 | 14.6 | 13.1 | 11.8 | 8.9 |
| | 32.5 | 45.0 | 13.7 | 12.7 | 10.8 | 6.7 |

This example shows that the experiments at similar pressure drop result into the smallest average oil droplet size at a negative overlap, namely at a displacement of −2.7 millimeter (length 81 as in FIG. 2 is 0.3 millimeter). And the displacement of millimeter yields smaller oil droplets than the displacement of −4 millimeter. Hence a shorter overlap (distance 8 as in FIG. 1) leads to a smaller average droplet size in this experiment. Also the flowrate is highest at the negative overlap, and this means that at the negative overlap not only the average oil droplet size is smallest, but also the throughput of the emulsion through the mixing device is highest.

### Example 2

A preferred apparatus according to the invention has the following layout and dimensions:

With reference to FIG. 1; a CDDM-like apparatus was operated having two concentric cylinders, distance between the two surfaces 7 was between 10 and 20 micrometer;

the length of the slit 8 was 80 micrometer (ratio between lengths 8 and 7 was 4 to 8); and wherein the length of the slit 8 plus the length of the cavity 17, 18 combined is maximally 10 millimeter;
the depth of the cavities 9, 10 is maximally 2 millimeter,
the internal diameter of the outer surface is about 25 millimeter,
total length of the apparatus is about 10 centimeter (length means the zone where the fluids are mixed).

Rotational speed of such a preferred apparatus is up to 25,000 rotations per minute.

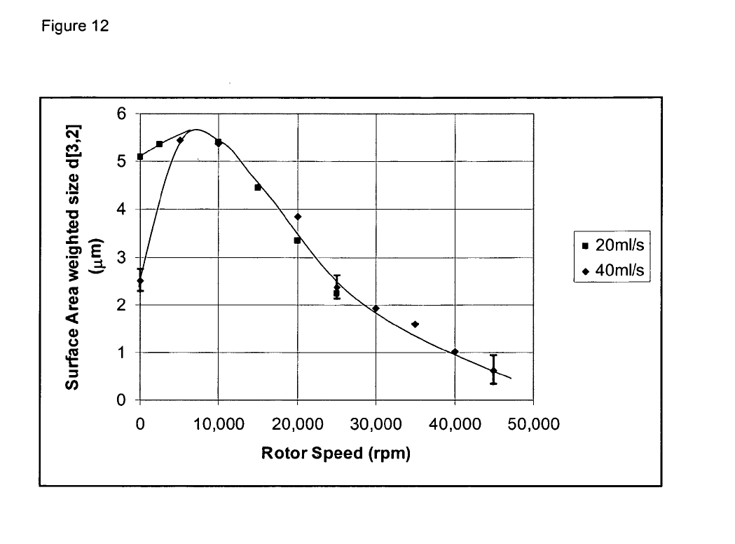

A model system of 5% sunflower seed oil in water, containing 0.1% emulsifier Pluronic F68, was pumped through the apparatus at various rotational speeds. This was done in order to emulsify the sunflower oil in water. The results of the experiments are given in FIG. 12.

The d_{3,2} (surface area weighted average diameter) as function of rotational speed has been indicated, for two flowrates of the emulsion. Remarkably at zero rotation the droplet size at a flow rate of 40 milliliter per second is similar to a rotational speed of 25,000 rpm. This means that much less energy is required to generate small droplets when the device is operated as a static mixer, as compared to a rotating device. At rotational speeds between 0 and 25,000 rpm, the obtained average droplet size is higher than at zero speed, while more energy is required in order to rotate the device.

### Example 3

A pre-made oil in water emulsion (comprising 93.75 wt % of a highly viscous (10,000 cP=10,000 mPa·s) silicone oil in a 15 wt % aqueous solution of SLES, and a d_{3,2} value of 2.47 micrometer) was pumped at various flowrates through the apparatus with an overlap between rotor and stator of 20 microns (8 in FIG. 1) but otherwise as specified in example 2, and operated at various rotational speeds and flow rates. The ratio between lengths 8 and 7 was 1 to 2. The d_{3,2} of the emulsions so produced was determined upon exit of the device. The results are tabulated below.

TABLE 4
Average droplet size of oil-in-water emulsion with high oil content.

| | rotational | pressure drop | flow rate | d_{3, 2} |
|---|---|---|---|---|
| exp. | speed [rpm] | [bar] | [liter per hour] | [micrometer] |
| 1 | 0 | 22.16 | 19.84 | 1.19 |
| 2 | 7,500 | 21.93 | 19.40 | 1.05 |
| 3 | 12,500 | 20.52 | 19.11 | 0.87 |
| 4 | 12,500 | 31.76 | 71.93 | 1.02 |

This emulsion is an extreme, as it has a very high oil content, and the oil has a high viscosity. The results show that apparatus of the present invention can effectively emulsify highly concentrated and high viscosity ratio oil in water emulsions both when operated with the confronting surfaces static and relatively moving. Also in static operation, the average d_{3,2} of the droplets is small. Nevertheless the energy consumption and input into the apparatus is relatively low, as there is no need to rotate at a high speed.

1. An apparatus for mixing at least two fluids, wherein the apparatus comprises two confronting surfaces (1, 2), spaced by a distance (7),
wherein the first surface (1) contains at least three cavities (3), wherein at least one of the cavities has a depth (9) relative to the surface (1),
wherein the second surface (2) contains at least three cavities (4) wherein at least one of the cavities has a depth (10) relative to the surface (2),
wherein the cross-sectional area for flow of the liquid available during passage through the apparatus successively increases and decreases at least 3 times, and
wherein the surface (1) has a length (5) between two cavities, and
wherein the surface (2) has a length (6) between two cavities, and
wherein the surfaces (1, 2) are positioned such that the corresponding lengths (5, 6) overlap to create a slit having a length (8) or do not overlap creating a length (81),
wherein the cavities are arranged such that the cross-sectional area for flow of the liquid available during passage through the apparatus successively increases in the cavities and decreases in the slits by a factor of at least 3, and
wherein the distance (7) between the two surfaces (1,2) is between 3 micrometers and 300 micrometers,
characterised in that
either the ratio between the length (8) and the distance (7) between the two surfaces (1, 2) ranges from 0 to 10,
or wherein the length (81) of overlap between the two surfaces (1, 2) is less than 600 micrometers.

2. An apparatus according to claim 1, wherein the cross-sectional area for flow of the liquid available during passage through the apparatus successively increases and decreases by a factor of at least 5, preferably at least 50.

3. An apparatus according to claim 1 or 2, wherein the cross-sectional area for flow of the liquid available during passage through the apparatus successively increases and decreases between 4 and 8 times.

4. An apparatus according to any of claims 1 to 3, wherein the distance (7) between surface (1) and surface (2) is between 5 micrometer and 100 micrometer, preferably between 15 micrometer and 25 micrometer.

5. An apparatus according to any of claims 1 to 3, wherein the ratio between the length (8) and the distance (7) between the two surfaces (1, 2) ranges from 0 to 5, preferably from 0 to 1.

6. An apparatus according to any of claims 1 to 5, wherein the ratio between the length (81) and the distance (7) between the two surfaces (1, 2) ranges from 0 to 30, preferably from 0 to 5, preferably from 0 to 1.

7. An apparatus according to any of claims 1 to 6, wherein the surfaces (1, 2) are substantially parallel flat surfaces.

8. An apparatus according to any of claims 1 to 6, wherein the two confronting surfaces (1, 2) are shaped and arranged as co-axial surfaces.

9. An apparatus according to claim 8, wherein one of the surfaces is able to rotate relative to the other surface, and wherein the direction of rotational movement is perpendicular to the direction of the bulk flow.

10. An apparatus according to claim 9, wherein one of the surfaces is able to rotate relative to the other surface at a frequency between 10 and 40,000 rotations per minute, preferably between 1,000 and 25,000 rotations per minute.

11. A method for mixing at least two fluids to create a mixture of the at least two fluids, wherein the at least two fluids are brought into contact in an apparatus according to any of claims 1 to 10.

12. A method according to claim 11, wherein the two confronting surfaces (1) and (2) of the apparatus are static.

13. A method according to claim 11 or 12, wherein the apparatus is operated at a pressure less than 200 bar, preferably less than 40 bar.

14. A method according to claim 12 or 13 for the production of an emulsion, wherein the at least two fluids comprise at least one hydrophobic fluid, and at least one hydrophilic fluid.

15. A method according to any of claims 11 to 14 for the production of an oil-in-water emulsion, wherein the concentration of the hydrophobic phase is at least 50% by weight, and wherein the dynamic viscosity of the hydrophobic phase is at least 1,000 mPa·s.
